(19) United States
(12) Patent Application Publication
(10) Pub. No.: US 2011/0042116 A1
(43) Pub. Date: Feb. 24, 2011

(54) ROTATING DEVICE

(75) Inventor: Janne Voimanen, Ylojarvi (FI)

Correspondence Address: DRINKER BIDDLE & REATH (DC), 1500 K STREET, N.W., SUITE 1100, WASHINGTON, DC, 20005-1209, US

(73) Assignee: SANDVIK MINING AND CONSTRUCTING OY, Tampere (FI)

(21) Appl. No.: 12/990,245

(22) PCT Filed: May 8, 2009
(86) PCT No.: PCT/FI09/50374

§ 371 Date: Oct. 29, 2010

(51) Int. Cl. E21B 15/00; F16H 35/18

(52) U.S. Cl. 173/190; 74/63

(57) ABSTRACT

A rotating device for rotating an apparatus arranged at the outer end of a boom, which boom has a longitudinal axis, the rotating device comprising a first torque motor unit arranged to rotate the apparatus substantially around an axis in the direction of the longitudinal axis of the boom, and a second torque motor unit arranged to rotate the apparatus around an axis that is at an angular position relative to the longitudinal axis of the boom, whereby the first and the second torque motor unit are arranged side by side relative to each other when seen in the direction of the longitudinal axis of the boom. The torque motor units are arranged in a body part common to both torque motor units.

The invention relates to a rotating device for rotating an apparatus arranged at the outer end of a boom, which boom has a longitudinal axis, the rotating device comprising a first torque motor unit arranged to rotate the apparatus substantially around an axis in the direction of the longitudinal axis of the boom, and a second torque motor unit arranged to rotate the apparatus around an axis that is at an angular position relative to the longitudinal axis of the boom, whereby the first and the second torque motor unit are arranged side by side relative to each other when seen in the direction of the longitudinal axis of the boom.

Typical rotating devices of the above type are presently well known, for instance in a technical field relating to rock drilling. In connection with rock drilling devices, it is known to use two separate drive motor-gear system combinations or torque motors which are positioned at an angle relative to each other and one after the other when seen in the longitudinal direction of the boom. Such a solution allows bolting holes to be drilled in the rock in a narrow tunnel on both sides close to the edge of the tunnel by means of a single-boom device.

In prior art, torque motors or drive motor-gear system combinations are fastened to each other by means of bolt fastening and/or with a separate connecting piece by means of bolt fastening.

One example of prior art solutions is the solution disclosed in PCT publication WO 2006/096110 A1. This known solution uses two units comprising a drive motor and a planetary gear system.

It is a disadvantage of the above-mentioned prior art that the drive motor gear system units or torque motors or/and a separate connecting piece or adapter, which generate the rotation providing the rotating movement of the apparatus arranged at the outer end of a boom, increase the contact surfaces, the weight and the length of the boom. A further disadvantage is that the distance of the rotation centres of separate drive motor units is great because the fastening members increase the length of the structure, depending on the construction. With regard to the length of the structure, it is further to be noted that when torque motors are used, the bearing of a horizontal torque motor is subjected to significant stresses if the distance of a vertical torque motor from the horizontal torque motor is great. The length of the structure increases, for its part, loads directed at the whole boom structure. The use of separate connecting pieces or adapters also increases the number of apparatus parts, which contributes to an increase in costs. Furthermore, it is a disadvantage that a large number of apparatus parts very easily leads to a complex structure whose usability is not the best possible and whose maintenance costs are disadvantageous.

A second example of the prior art is an apparatus described in U.S. Pat. No. 4,799,556. This known solution uses two torque motor units arranged side by side relative to each other when seen in the direction of the longitudinal axis of the boom. The solution comprises, however, several separate parts etc., by means of which the torque motor units are fastened to each other, so the final result is complex and has, to a great extent, the same disadvantages as what is explained above in the context of the solution of PCT publication WO 2006/096110 A1.

An object of the invention is to provide a rotating device by means of which prior art disadvantages can be eliminated. This has been achieved with a rotating device according to the invention, characterized in that the torque motor units are arranged in a body part common to both torque motor units.

An advantage of the invention is, above all, that it provides a very short structure compared with the prior art, so the load of the bearing of the horizontal torque motor unit can be reduced compared with long solutions according to the prior art. This enables the use of short torque motor units in which the distance of internal bearings is small. The positioning of the torque motor units according to the invention moves the drilling centre of the vertical torque motor unit backwards even by one meter, so the structure can utilize smaller components and solutions in the design of the boom or alternatively greater drilling forces and feeding devices. A further advantage of the invention is that the invention allows the rotation centres of the torque motors to be brought close to each other. An advantage of the invention is also that the number of parts is reduced if the solution is used instead of a face drilling boom according to the prior art. Components which are not needed any longer include a bolting cylinder, a cradle fastening stand, a hardened shaft of the cradle, bronze bearings and the like components.

The invention will now be described in greater detail with reference to an embodiment example shown in the attached drawing, whereby

FIG. 1 shows a principled view of a boom of a rock drilling device according to the prior art;

FIG. 2 shows a principled view of a boom of a rock drilling device provided with a rotating device according to the invention;

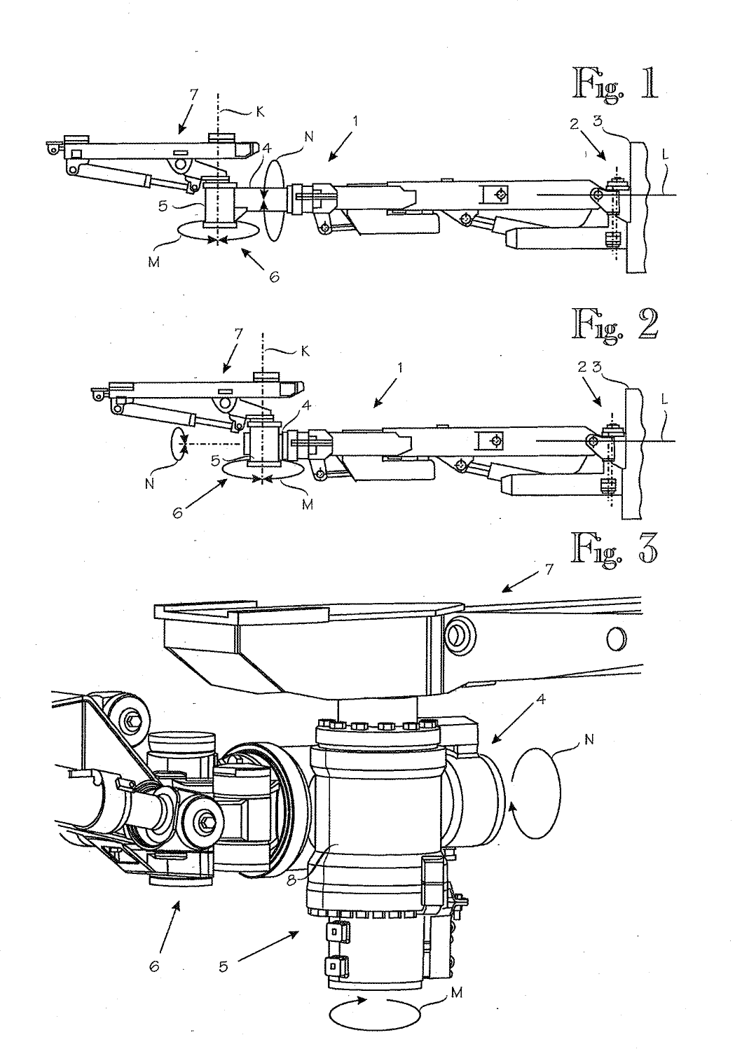

FIG. 3 shows a perspective view of a rotating device according to the invention, installed at the outer end of a boom;

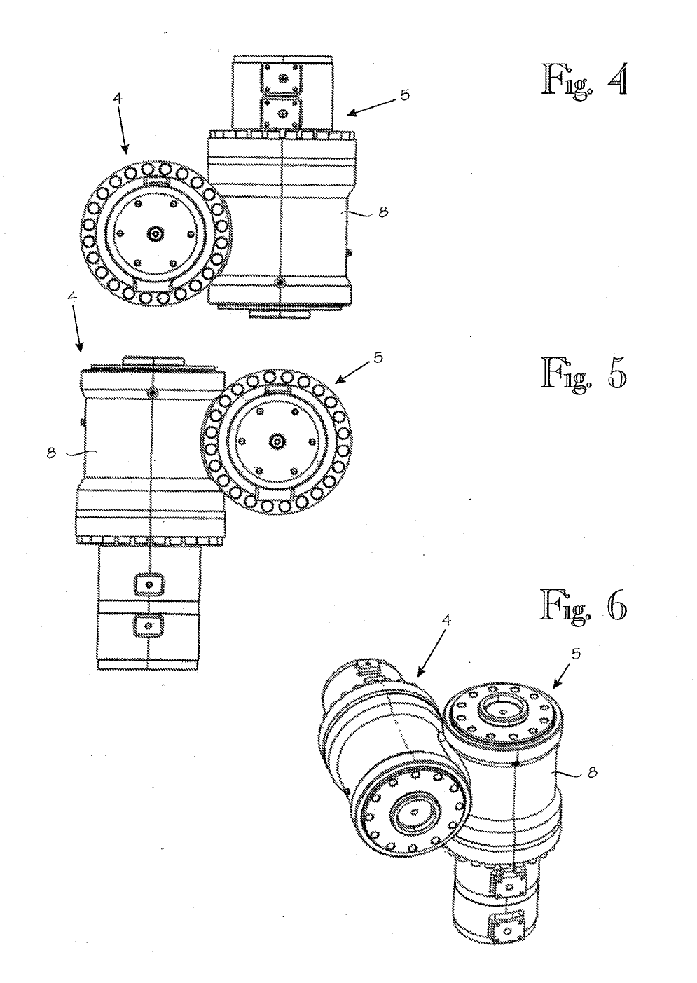

FIGS. 4 to 6 show a rotating device according to the invention as views seen from different directions; and

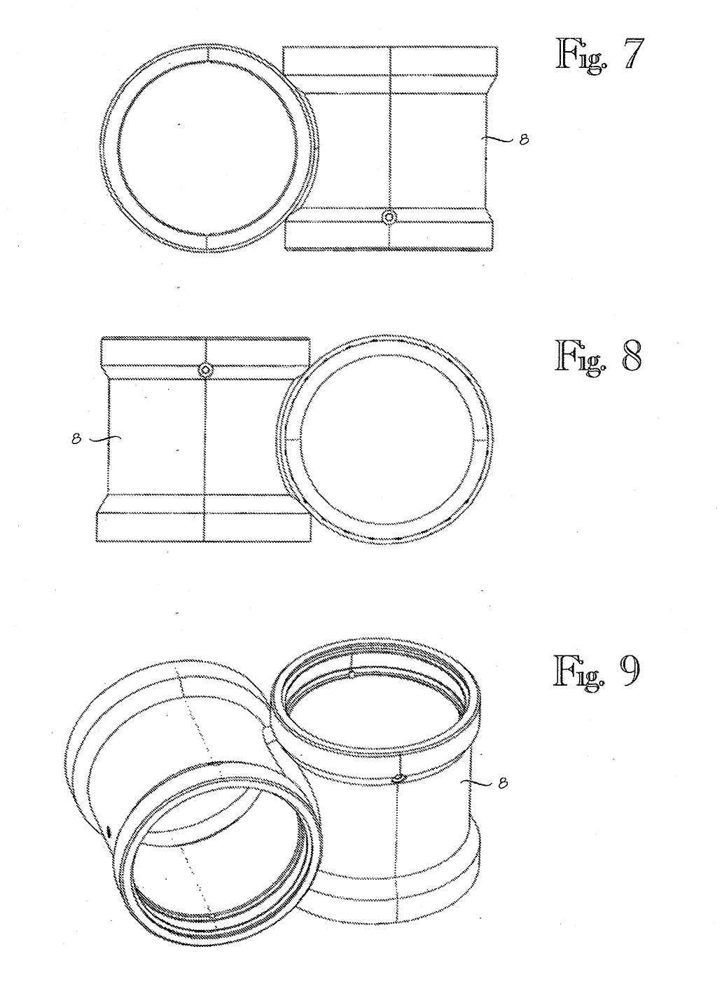

FIGS. 7 to 9 show a body part of a rotating device according to the invention as views seen from different directions.

FIG. 1 shows, by way of principle, a boom 1 provided with a rotating device according to the prior art. The boom may be, for example, a telescopically extendable boom which can be turned in different directions. The operation and structure of such booms, i.e. the different parts, such as boom elements, hydraulic cylinders and the like components and the operation thereof, are completely conventional technology to a person skilled in the art, so these details will not be described further in this context.

The boom 1 according to FIG. 1 is intended to be fastened by its one end 2 to a base moving on wheels, for example. The base is denoted, by way of principle, with reference numeral 3 in FIG. 1. The structure and operation of the above bases are completely conventional technology to a person skilled in the art, so these aspects will not be described in more detail in this context.

The example of FIG. 1 uses a first drive motor unit 4 and a second drive motor unit 5 for rotating an apparatus 7 arranged at an outer end 6 of the boom in a desired manner, so that the apparatus 7 can be turned in a desired direction.

As shown in FIG. 1, the first drive motor unit 4 is arranged to rotate the apparatus 7 arranged at the outer end 6 of the boom substantially around an axis in the direction of the longitudinal axis L of the boom. The apparatus 7 arranged at the outer end of the boom 1 may be, for example, a rock drill with its equipment.

The movement generated by the first drive motor unit 4 is shown, by way of principle, with arrow N in FIG. 1.

The second drive motor unit 5, in turn, is arranged to rotate the apparatus 7 arranged at the outer end of the boom around an axis K, which is in an angular position, preferably at an angle of 90 degrees relative to the longitudinal axis L of the boom. This movements is denoted, by way of principle, with arrow M in FIG. 1.

The drive motor units 4 and 5 of the example of FIG. 1 may be any normal, commercially available components which are used in the field and whose basic structure and operation are completely conventional and belong to the professional knowledge of a person skilled in the art. Thus, these aspects will not be described in more detail in this context. The drive motor units may be, for example, drive motor-gear system units or torque motor units, as noted above.

In the example of FIG. 1, the first and the second drive motor unit 4 and 5 are in successive positions. It is to be noted that FIG. 1 is a principled view, in other words it shows the basic principle of the structure. There may be a connecting piece, an adapter or another corresponding element between the drive motor units 4 and 5, which contributes to an increase in the length of the boom. In this context, a reference is made for example to PCT publication WO 2006/096110 A1, which was cited earlier as prior art.

FIG. 2 shows, by way of principle, a boom provided with a rotating device according to the invention. FIG. 2 uses the same reference numerals as FIG. 1 at corresponding points.

In the embodiment of FIG. 2, the drive motor units 4 and 5 are torque motor units. Torque motor units are known as such in the field and involve converting the linear movement of a piston into rotating movement by means of gear transmission.

According to the basic idea of the invention, the first and the second torque motor unit 4, 5 are arranged side by side relative to each other when seen in the direction of the longitudinal axis L of the boom 1. This provides a significantly short structure, which is preferable, as noted earlier. In the prior art, torque motor units are arranged one after the other, for instance, when seen in the direction of the longitudinal axis of the boom, which leads to a long structure. The above aspects become apparent when comparing FIGS. 1 and 2 with each other.

Torque motors have been positioned side by side earlier as well, as in U.S. Pat. No. 4,799,556. The device according to U.S. Pat. No. 4,799,556 is, however, technically complex and requires numerous separate parts, so the final result is not the best possible.

An object of the invention is to eliminate disadvantages of the prior art and to provide a rotating device which leads to a short structure in a simple manner. This has been provided by arranging the torque motor units in a body part 8 common to both torque motor units. The common body part 8 is shown in FIGS. 3 to 9.

FIG. 3 shows a perspective view of a rotating device according to the invention. FIG. 3 uses the same reference numerals as FIGS. 1 and 2 at corresponding points.

FIGS. 4 to 6 show a rotating device according to the invention as views seen in different directions. FIGS. 4 to 6 use the same reference numerals as FIG. 3 at corresponding points.

FIGS. 7 to 9 show an essential element of the rotating device according to the invention, i.e. a body part 8 common to both torque motor units, as views seen from different directions. By means of the integrated body structure of FIGS. 7 to 9, a short, compact and simple body is provided for both torque motor units 4, 5. As can be seen from the figures, the body part 8 is formed as a continuous part surrounding both torque motor units 4, 5.

The basic idea of the above-described invention can be preferably implemented in such a way that the body part 8 is formed in such a way that the second torque motor unit 5 is arranged on the side of the first torque motor unit 4. In this way, the torque motor units 4, 5 can be positioned simply and preferably as close to each other as possible.

The common body part 8 is thus formed as a continuous piece on which both toque motor units 4, 5 are positioned. Owing to the body part common to both torque motor units 4, 5, the torque centres of the torque motor units can be positioned preferably very close to each other. This aspect is clearly seen from FIGS. 4 to 9.

The directions of the torque motor units 4, 5 can vary relative to each other. It is preferable, however, that the directions of the rotating axes of the torque motor units are substantially at an angle of 90 degrees relative to each other, as shown in the examples of the figures.

The invention has been described above with reference to a rock drilling device. However, the invention is not, by any means, confined to rock drilling devices but the rotating device according to the invention can also be applied in connection with booms intended for other purposes.

The invention is not, by any means, confined to the examples of the figures either but may be modified completely freely within the scope of the claims. Thus, details of the rotating device according to the invention may, even to a great extent, deviate from the examples of the figures.

1. A rotating device for rotating an apparatus arranged at the outer end of a boom, which boom has a longitudinal axis (L), the rotating device comprising a first torque motor unit arranged to rotate the apparatus substantially around an axis (L) in the direction of the longitudinal axis of the boom, and a second torque motor unit arranged to rotate the apparatus around an axis (K) that is at an angular position relative to the longitudinal axis (L) of the boom, whereby the first and the second torque motor unit are arranged side by side relative to each other when seen in the direction of the longitudinal axis (L) of the boom, wherein the torque motor units are arranged in a body part common to both torque motor units.

2. A rotating device according to claim 1, wherein the body part is formed in such a way that the second torque motor unit is attached to the side of the first torque motor unit.

3. A rotating device according to claim 1, wherein the body part is formed as a continuous piece.

4. A rotating device according to claim 1, wherein the body part is arranged to surround both torque motor units.

5. A rotating device according to claim 1, wherein the directions of the rotating axes of the torque motors are substantially at an angle of 90 degrees relative to each other.

6. A rotating device according to claim 1, wherein the boom is a boom of a rock drilling device.

7. A rotating device according to claim 2, wherein the body part is formed as a continuous piece.

8. A rotating device according to claim 2, wherein the body part is arranged to surround both torque motor units.

9. A rotating device according to claim 3, wherein the body part is arranged to surround both torque motor units.
